(19) United States
(12) Patent Application Publication
(10) Pub. No.: US 2025/0166225 A1
(43) Pub. Date: May 22, 2025

(54) Computer Vision Systems and Methods for Detecting Structures Using Aerial Imagery and Heightmap Data

(71) Applicant: Insurance Services Office, Inc., Jersey City, NJ (US)

(72) Inventor: Ryan Mark Justus, Lehi, UT (US)

(73) Assignee: Insurance Services Office, Inc., Jersey City, NJ (US)

(21) Appl. No.: 18/953,486

(22) Filed: Nov. 20, 2024

Related U.S. Application Data
(60) Provisional application No. 63/600,943, filed on Nov. 20, 2023.

(51) Int. Cl. G06T 7/73; G06T 11/60; G06V 10/82; G06V 20/13; G06V 20/17

(52) U.S. Cl. CPC G06T 7/74; G06T 11/60; G06V 10/82; G06V 20/13; G06V 20/17; G06T 2207/10032; G06T 2207/20221

(57) ABSTRACT

Computer vision systems and methods for detecting structures using aerial imagery and heightmap data are provided. The system receives aerial imagery and at least one heightmap, and merges the aerial imagery and the heightmap to create a combined image. The system determines one or more structures of the land property based at least in part on the combined image and a computer vision model, which can detect one or more objects in the combined image. The system can generate and place a bounding box or a polygon around each of the detected objects, and generate and assign a structure classification to the bounding box or the polygon to indicate the structure of the object. The system can also determine a geographic location of each structure using the two-dimensional (2D) spatial information of the aerial imagery and the depth information of the heightmap.

### BACKGROUND TECHNICAL FIELD

This application claims priority to U.S. Provisional Patent Application Ser. No. 63/600,943 filed on Nov. 20, 2023, the entire disclosure of which is hereby expressly incorporated by reference.

### TECHNICAL FIELD

The present disclosure relates generally to the field of computer vision. More specifically, the present disclosure relates to computer vision systems and methods for detecting structures using aerial imagery and heightmap data.

### RELATED ART

There is an ever-increasing use of aerial imagery from aircraft or satellites for building/property analysis. For example, in the property insurance industry, several companies are starting to use aerial imagery to inspect properties, analyze property structures, and to estimate land area, constructional assets, and other information. However, detecting property structures in images is a challenging task, as structures are sometimes difficult or impossible to perceive with the naked eye in greater detail (especially when viewed from larger overhead distances). Moreover, the foregoing operations involving multiple human operators are cumbersome and are prone to human error. In some situations, the human operator may not be able to accurately and thoroughly capture all structures and recognize classifications of the structures, which may result in inaccurate assessment and human bias errors.

Thus, what would be desirable are computer vision systems and methods for detecting structures using aerial imagery and heightmap data, which address the foregoing, and other, needs.

### SUMMARY

The present disclosure relates to computer vision systems and methods for detecting structures using aerial imagery and heightmap data. The system receives aerial imagery and at least one heightmap. The aerial imagery and the heightmap include the same land property (e.g., a resource insured and/or owned by a person or a company). The system merges the aerial imagery and the heightmap to create a combined image by aligning the heightmap with the aerial imagery, mean shifting a plurality of values in the heightmap to zero, resizing the heightmap to the same size of the aerial imagery, and concatenating the aerial imagery and the heightmap to create the combined image. The system determines one or more structures of the land property based at least in part on the combined image and a computer vision model (e.g., a convolutional neural network). The computer vision model can detect one or more objects (e.g., roof, pool, fences, boundaries of the land property, etc.) in the combined image, generate and place a bounding box or a polygon (e.g., footprint polygon) around each of the detected objects, and generate and assign a structure classification to the bounding box or the polygon to indicate the structure of the object. The system determines a geographic location (e.g., a coordinate in the real world) of each structure using the two-dimensional (2D) spatial information of the aerial imagery and the depth information of the heightmap. The system can store data associated with the combined image including, but limited to, geographic coordinates, footprint polygons, bounding boxes, structure classifications, timestamps of the aerial imagery and heightmap, other suitable metadata in a geospatial database for use and/or further analysis.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating an embodiment of the system of the present disclosure;

FIG. 2 is a flowchart illustrating overall processing steps carried out by the system of the present disclosure;

FIG. 3 is a flowchart illustrating step 54 of FIG. 2 in greater detail;

FIG. 4 is a flowchart illustrating step 56 of FIG. 2 in greater detail;

FIG. 5 is a flowchart illustrating step 58 of FIG. 2 in greater detail;

FIG. 6 is a diagram illustrating example operations of overall processing steps of FIG. 2;

FIG. 7 is a diagram illustrating hardware and software components capable of being utilized to implement the system of the present disclosure; and

FIGS. 8-9 are illustrations of the processing steps of FIGS. 3-4.

### DETAILED DESCRIPTION

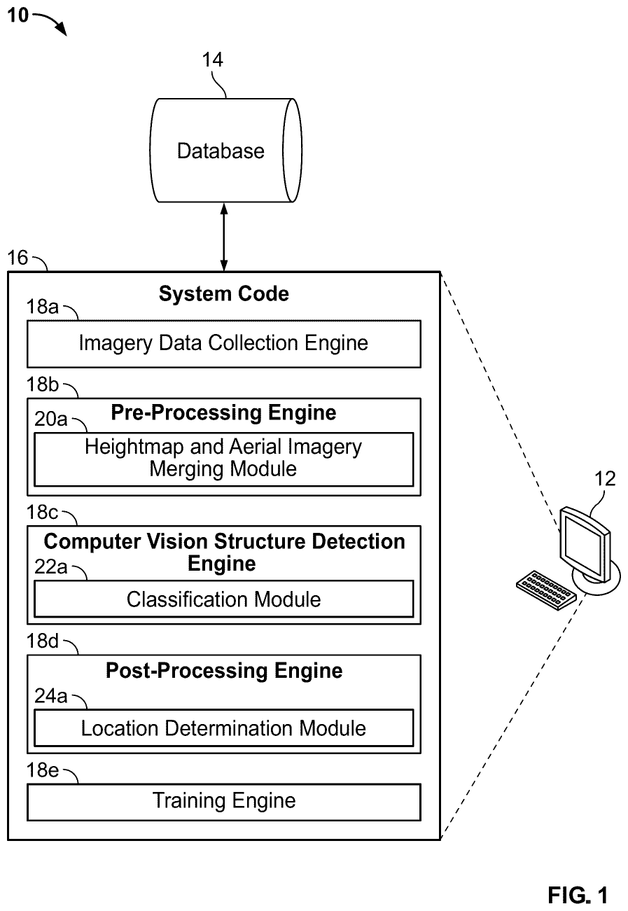

The present disclosure relates to computer vision systems and methods for detecting structures using aerial imagery and heightmap data, as described in detail below in connection with FIGS. 1-9.

Turning to the drawings, FIG. 1 is a diagram illustrating an embodiment of the system 10 of the present disclosure. The system 10 can be embodied as a central processing unit 12 (processor) in communication with a database 14. The processor 12 can include, but is not limited to, a computer system, a server, a personal computer, a cloud computing device, a smart phone, or any other suitable device programmed to carry out the processes disclosed herein. Still further, the system 10 can be embodied as a customized hardware component such as a field-programmable gate array (“FPGA”), an application-specific integrated circuit (“ASIC”), embedded system, or other customized hardware components without departing from the spirit or scope of the present disclosure. It should be understood that FIG. 1 is only one potential configuration, and the system 10 of the present disclosure can be implemented using a number of different configurations.

The database 14 includes data associated with one or more land properties. Land property can be a resource insured and/or owned by a person or a company. Examples of land property can include residential properties such as single family, condo/townhouse, mobile home, multi-family and other, and commercial properties such as a company site, a commercial building, a retail store, etc.), or any other suitable land properties.

The database 14 can include various types of data including, but not limited to, imagery data (e.g., aerial imagery, videos, heightmap data or the like) indicative of land property as described below, one or more outputs from various components of the system 10 (e.g., outputs from an imagery data collection engine 18a, a pre-processing engine 18b, a heightmap and aerial imagery merging module 20a, a computer vision structure detection engine 18c, a classification module 22a, a post-processing engine 18d, a location determination module 24a, a training engine 18e, and/or other components of the system 10), one or more computer vision models (e.g., machine learning models and/or deep learning models), and associated training data.

The imagery data can include digital images and/or digital image datasets including ground images, aerial images, satellite images, etc. where the digital images and/or digital image datasets could include, but are not limited to, images of land property. Additionally and/or alternatively, the imagery data can include videos of land property, and/or frames of videos of land property. An aerial image can be an image taken from a satellite or an airborne platform (e.g., an aircraft, helicopters, unmanned aerial vehicles, balloons, and/or other suitable airborne platform) along a particular direction (e.g., a vertical/nadir direction toward a land surface, or other suitable direction that can be used to capture the land property). The imagery data can also include heightmap data (e.g., point clouds, depth maps, light detection and ranging (LiDAR) files) associated with one or more land properties. The heightmap data includes a heightmap (e.g., a raster image where each pixel stores elevation data) and metadata (e.g., including, but not limited to, location and depth information for each pixel, resolution information, setting information for capturing the heightmap, and/or other suitable information describing/associated with the heightmap). The heightmap data can be collected via a digital surface model, LiDAR files, stereo imagery, or other suitable system/method capable of generating/retrieving elevation data. The system 10 could generate three-dimensional (3D) information/representation of land property based on the digital images/digital image datasets and heightmap data. As such, by the terms “imagery” and “image” as used herein, it is meant not only two-dimensional (2D) imagery and computer-generated imagery, but also 3D imagery.

The system 10 includes system code 16 (non-transitory, computer-readable instructions) stored on a computer-readable medium and executable by the hardware processor 12 or one or more computer systems. The system code 16 can include various custom-written software modules that carry out the steps/processes discussed herein, and can include, but is not limited to, the imagery data collection engine 18a, the pre-processing engine 18b, the heightmap and aerial imagery merging module 20a, the computer vision structure detection engine 18c, the classification module 22a, the post-processing engine 18d, the location determination module 24a, the training engine 18e, and/or other components of the system 10. The system code 16 can be programmed using any suitable programming languages including, but not limited to, C, C++, C#, Java, Python, or any other suitable language. Additionally, the system code 16 can be distributed across multiple computer systems in communication with each other over a communications network, and/or stored and executed on a cloud computing platform and remotely accessed by a computer system in communication with the cloud platform. The system code 16 can communicate with the database 14, which can be stored on the same computer system as the code 16, or on one or more other computer systems in communication with the code 16.

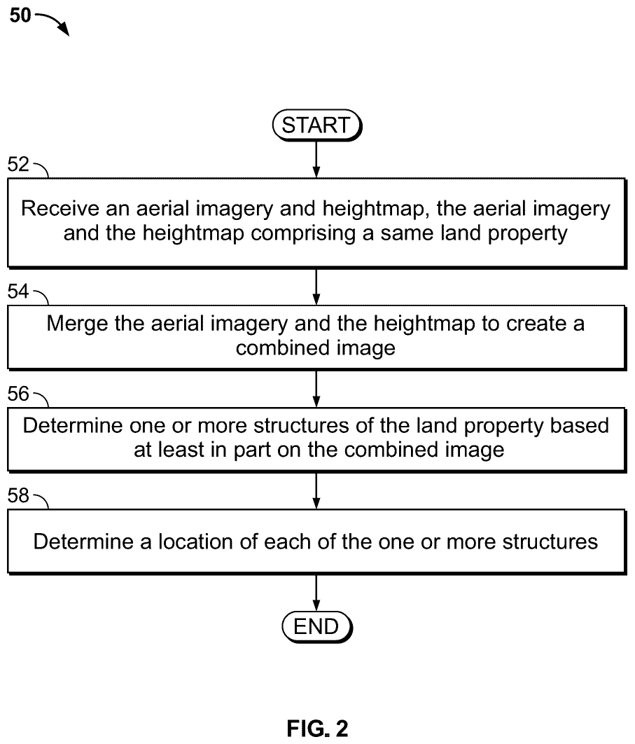

FIG. 2 is a flowchart illustrating overall processing steps 50 carried out by the system 10 of the present disclosure. Beginning in step 52, the system 10 receives an aerial imagery and a heightmap. The aerial imagery and the heightmap include the same land property. The aerial imagery and the heightmap can have the same image size and/or image resolution or different image sizes and/or image resolutions. For example, the heightmap can have a lower or higher image resolution and a smaller or larger image size than those of the aerial imagery. The metadata associated with the heightmap can include location and depth information for each pixel in the heightmap to locate each pixel in real world. The aerial imagery can include data and/or metadata to locate a position (e.g., a position in real world) of each pixel in the aerial imagery when given a plane in world on which that pixel may lie. The aerial imagery can be oriented along a particular direction, such as a vertical direction (e.g., a nadir direction), an angled direction, or other suitable direction that captures the land property. Further, the aerial imagery can be orthorectified by a process of removing effects of image perspective (tilt) and relief (terrain) effects for creating a planimetrically correct image. Multiple sub-images corresponding to multiple regions can be stitched together to form the aerial imagery having a larger region than the sub-images. The aerial imagery can also have multiple color channels, including, but not limited to a red channel, a green channel, a blue channel, an infrared channel, or other suitable color channel. It should be understood that the foregoing processing steps can be performed by the imagery data collection engine 18a.

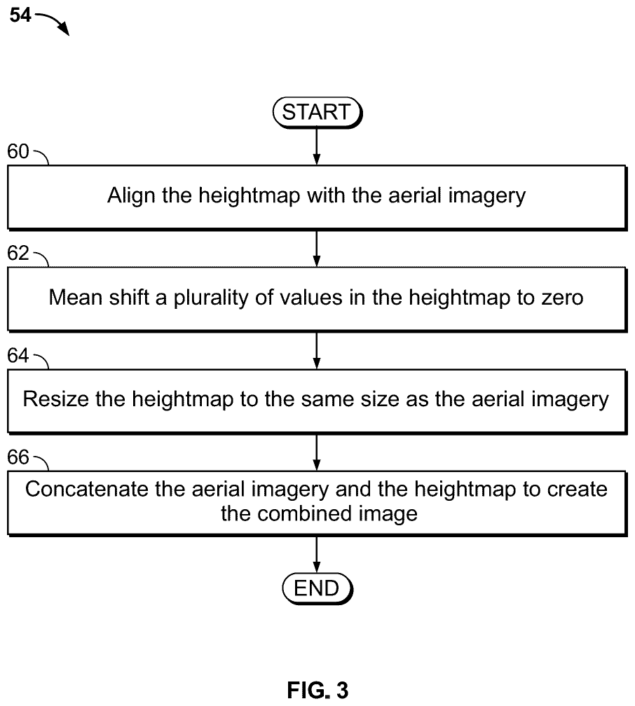

In step 54, the system 10 merges the aerial imagery and the heightmap to create a combined image. For example, the system 10 can process the heightmap (e.g., adjusting the image size, the image resolution, and/or other suitable image processing to process the heightmap) to be in line with the aerial imagery. The system 10 can concatenate the aerial imagery and the processed heightmap to produce the combined image that can be an image having combined information (e.g., spatial information, structural information, etc.) from both the aerial imagery and heightmap. It should be understood that the foregoing steps can be performed by the pre-processing engine 18b. Example operations of step 54 are further described with respect to FIG. 3.

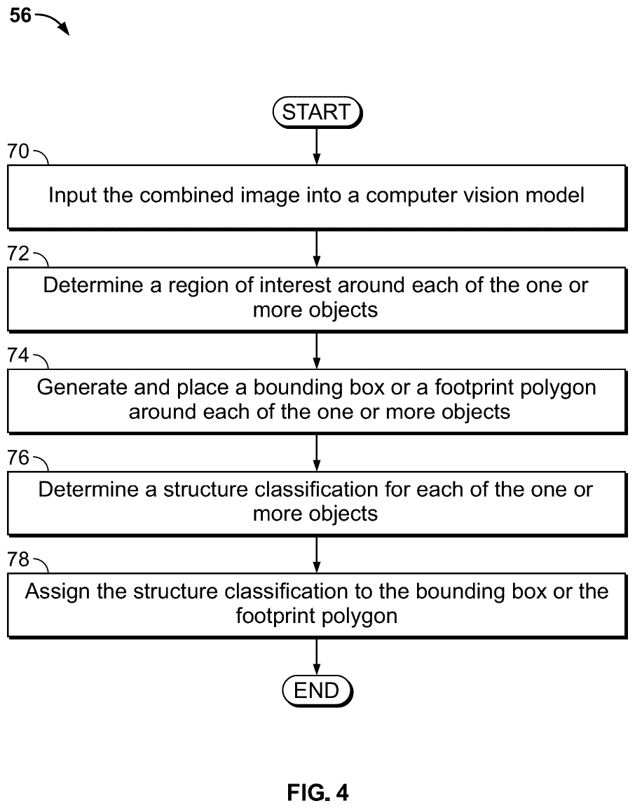

In step 56, the system 10 determines one or more structures of the land property based at least in part on the combined image. The system 10 can include a computer vision model to determine a structure classification or prediction for an object (e.g., roof, pool, fences, boundaries of the land property, etc.) of the land property. A computer vision model can include a machine learning model and/or a deep learning model (e.g., convolutional neural network, or other suitable neural network) via supervised learning, semi-supervised learning, and/or unsupervised learning. It should be understood that the foregoing steps can be performed by the computer vision structure detection engine 18c and the training engine 18e. Example operations of step 56 are further described with respect to FIG. 4.

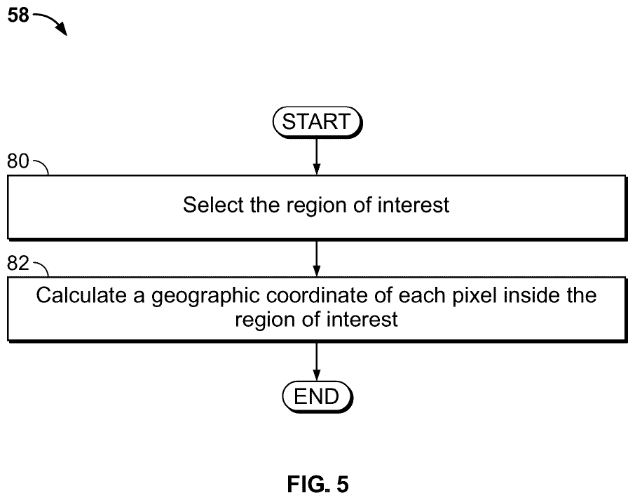

In step 58, the system 10 determines a location of each of the one or more structures. The system 10 can calculate a geographic location for each structure using location information of the aerial imagery and the heightmap. It should be understood that the foregoing steps can be performed by the post-processing engine 18d. Example operations of step 58 are further described with respect to FIG. 5.

FIG. 3 is a flowchart illustrating step 54 of FIG. 2 in greater detail. Beginning in step 60, the system 10 aligns the heightmap with the aerial imagery. The system 10 can process the aerial imagery and heightmap for spatial mapping (e.g., the same scene of the aerial image and heightmap are aligned). For example, the system 10 can transform the aerial imagery and heightmap into one coordinate system via various image alignment and/or image resignation techniques, such as intensity-based algorithms, feature-based algorithms, linear transformation models (e.g., including rotation, scaling, translation, and other affine transforms), non-rigid transformation models (e.g., including radial basis functions and deformation models), spatial domain methods, frequency domain methods, or other suitable image alignment and/or image resignation techniques. The aerial imagery can be a target or fixed image, and the heightmap can be a moving or source image, or vice versa.

In step 62, the system 10 mean shifts a plurality of values in the heightmap to zero. For example, the system 10 can determine a location of the densest region of the plurality of values and move the location of the densest region to zero. In step 64, the system 10 resizes the heightmap to the same size of the aerial imagery. For example, the system 10 can scale the heightmap by increasing or decreasing the number of pixels of the heightmap to match the image size of the aerial imagery via various image processing technologies, such as nearest-neighbor interpolation, bilinear interpolation, bicubic interpolation, resampling techniques, deep convolutional neural networks, Fourier-transform methods, edge-directed interpolation, and/or other suitable image scaling/resizing techniques. In step 66, the system 10 concatenates the aerial imagery and the heightmap to create the combined image. The system 10 can gather information from the aerial imagery and heightmap and merge the aerial imagery and heightmap into an image that has all information (e.g., spatial information, depth information, location information, etc.) from both image.

FIG. 4 is a flowchart illustrating step 56 of FIG. 2 in greater detail. Beginning in step 70, the system 10 inputs the combined image into a computer vision model. The computer vision model (e.g., a convolutional neural network) can be trained via supervised learning using training datasets (e.g., ground truth datasets of images with heightmaps and structure labels). The computer vision model can also be sourced from a pre-trained model. In step 72, the system 10 determines a region of interest around each of the one or more objects (e.g., pool, fences, roof, etc.) in the combined image. The system 10 can utilize the computer vision model to perform an instance segmentation task, such that the computer vision model can detect each objects in the combined image and predicts a region of interest (e.g., a region of the combined image belonging to a particular object) for each object to specify which pixels are to be considered part of the object.

In step 74, the system 10 generates and places a bounding box or a polygon around each of the one or more objects. For example, the system 10 can generate a bounding box (e.g., a rectangular/square box) around the predicted region of interest. The bounding box can be axis aligned or object aligned. Additionally and/or alternatively, the system 10 can generate one or more polygons that label the boundaries of the predicted region of interest. For example, the system 10 can generate a segmentation mask for each object and extract the contour of the mask to produce a polygon.

In step 76, the system 10 determines a structure classification for each of the one or more objects. The system 10 can utilize the computer vision model to recognize the structure of each of the one or more objects. For example, the system 10 can use a classifier (e.g., a binary classifier, a multi-classifier, or some combination thereof) to identify an object as belonging to a structure classification. The classifier can be part of the computer vision model. In step 78, the system 10 assign the structure classification to the bounding box or the footprint polygon. For example, the system 10 outputs and locates a bounding box or a footprint polygon around a particular object and label the bounding box or the footprint polygon with the structure classification for that object.

FIG. 5 is a flowchart illustrating step 58 of FIG. 2 in greater detail. Beginning in step 80, the system 10 selects the region of interest. For example, if the system 10 uses a bounding box to locate an object in the combined image, the system 10 selects the bounding box to select the region of interest. If the system 10 uses a footprint polygon to locate an object in the combined image, the system 10 selects the foot polygon to select the region of interest. In step 82, the system 10 calculates a geographic coordinate inside the region of interest. For example, the system 10 can determine a 2D/3D geographic coordinate (e.g., a coordinate in real world) of each pixel inside the bounding box or the footprint polygon. As described above, the heightmap is aligned with the aerial imagery such that the heightmap and aerial imagery are in the same coordinate system (e.g., a world coordinate system). The combined image includes the 2D spatial information from the aerial imagery and the depth information from the heightmap. The system 10 can calculate a 3D geographic coordinate of each pixel from the 2D spatial information and the depth information of the combined image (e.g., metadata of the aerial imagery and heightmap). If the combined image is orthorectified, the system 10 can calculate geographic coordinates of the corners of the bounding box or the footprint polygon and interpolate geographic location values based on the geographic coordinates of the corners. If the heightmap and the aerial imagery are aligned in a different coordinate system (e.g., in an imaging space) rather than a world coordinate system (e.g., in a geographic space), the system 10 can convert coordinates to geographic coordinates. For example, if the combined image is from a perspective imaging device (e.g., a camera), the system 10 can backproject each pixel inside the region of interest to obtain a ray pointing from the imaging device to a pixel location of that pixel. The system 10 can further intersect the ray with a horizontal plane constructed with a height value of that pixel location to obtain a 3D geographic coordinate of that pixel. Further, the system 10 can estimate a polygon that matches a world coordinate polygon to provide a geographic coordinate with or without additional constraints regarding angles between line segments or any other geometric constraint. The system 10 can also merge adjacent co-linear segments to form the polygon.

If the system 10 detects multiple objects in the combined image and each object is labeled with a region of interest, the system 10 can select another region of interest to determine geographic coordinates for that region of interest. The system 10 can store data associated with the combined image including, but limited to geographic coordinates, footprint polygons, bounding boxes, structure classifications, timestamps of the aerial imagery and heightmap, other suitable metadata and/or data associated with each step with respect to FIGS. 2-5 in the database 14 and/or a geospatial database for use and/or further analysis.

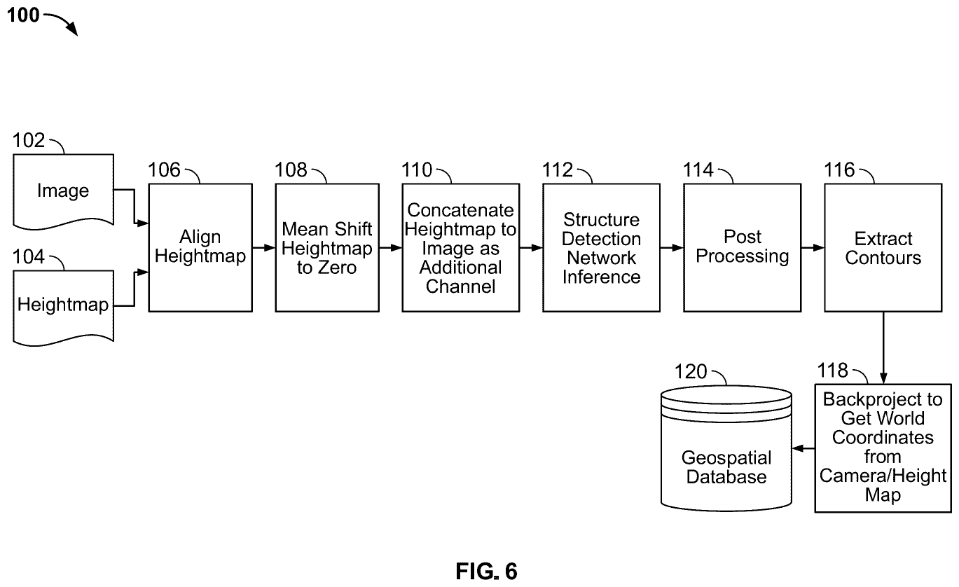

FIG. 6 is a diagram 100 illustrating the overall processing steps of FIG. 2. Beginning in step 102, the system 10 receives an image 102 (e.g., an aerial imagery) and a heightmap 104. Examples of the image 102 and heightmap 104 are described with respect to FIG. 2. In step 106, the system 10 aligns the heightmap 104 with the image 102. Example operations of the image alignment are described above with respect to FIG. 3. In step 108, the system 10 mean shifts values in the heightmap 104 to zero. Example operations of the mean shifting process are described above with respect to FIG. 3. In step 110, the system 10 concatenates the image 102 and the heightmap 104 to create an image having a depth channel. Example operations of image merging are described above with respect to FIG. 3. In step 112, the system 10 detects a structure for each object in the created image using a structure detection network inference model (e.g., a computer vision model described above with respect to FIGS. 2 and 4). Example of operations of the structure detection are described above with respect to FIG. 4. In step 114, the system 10 post- processes the output from the structure detection network inference model and the combined image for further analysis. For example, the system 10 selects a region of interest and/or generates a segmentation mask for a detected object. The system 10 can estimate a polygon that matches a world coordinate polygon for a detected object. Example operations are described above with respect to FIG. 5. In step 116, the system 10 extracts one or more contours of the segmentation mask. Example operations are described above with respect to FIG. 5. In step 118, the system 10 backprojects locations in the combined image to get world coordinates (e.g., geographic coordinates) from metadata associated with the image 102 and the heightmap 104 and/or imaging devices (e.g., cameras) that capture the image 102 and the heightmap 104. Example operations are described above with respect to FIG. 5. In step 120, the system 10 stores data associated with the combined image including, but limited to the 3D geographic coordinates, footprint polygons, bounding boxes, structure classifications, timestamps of the aerial imagery and heightmap, other suitable metadata and/or data associated with foregoing steps in a geospatial database (e.g., the database 14) for use and/or further analysis.

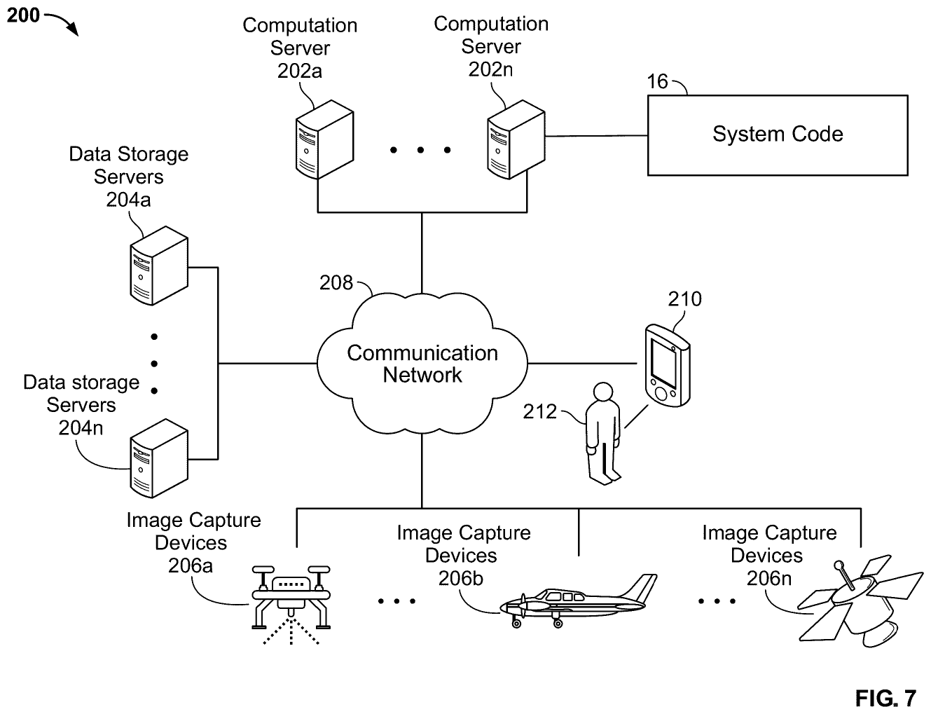

FIG. 7 is a diagram illustrating hardware and software components capable of being utilized to implement the system 200 of the present disclosure. The system 200 can include a plurality of computation servers 202a-202n having at least one processor (e.g., one or more graphics processing units (GPUs), microprocessors, central processing units (CPUs), tensor processing units (TPUs), application-specific integrated circuits (ASICs), etc.) and memory for executing the computer instructions and methods described above (which can be embodied as system code 16). The system 200 can also include a plurality of data storage servers 204a-204n for storing metadata and/or data (e.g., including, but limited to the aerial imagery, the heightmap, 3D geographic coordinates, footprint polygons, bounding boxes, structure classifications, timestamps of the aerial imagery and heightmap, other suitable metadata and/or data associated with each processing step). The system 200 can also include a plurality of image capture devices 206a-206n for capturing the aerial imagery and the heightmap. For example, the camera devices can include, but are not limited to, an unmanned aerial vehicle 206a, an airplane 206b, and a satellite 206n. A user device 210 can include, but it not limited to, a laptop, a smart telephone, and a tablet to display an aerial imagery, a heightmap, a combined image, and/or outputs from a computer vision model for structure detection. The computation servers 202a-202n, the data storage servers 204a-204n, the image capture devices 206a-206n, and the user device 210 can communicate over a communication network 208. Of course, the system 200 need not be implemented on multiple devices, and indeed, the system 200 can be implemented on a single (e.g., a personal computer, server, mobile computer, smart phone, etc.) without departing from the spirit or scope of the present disclosure.

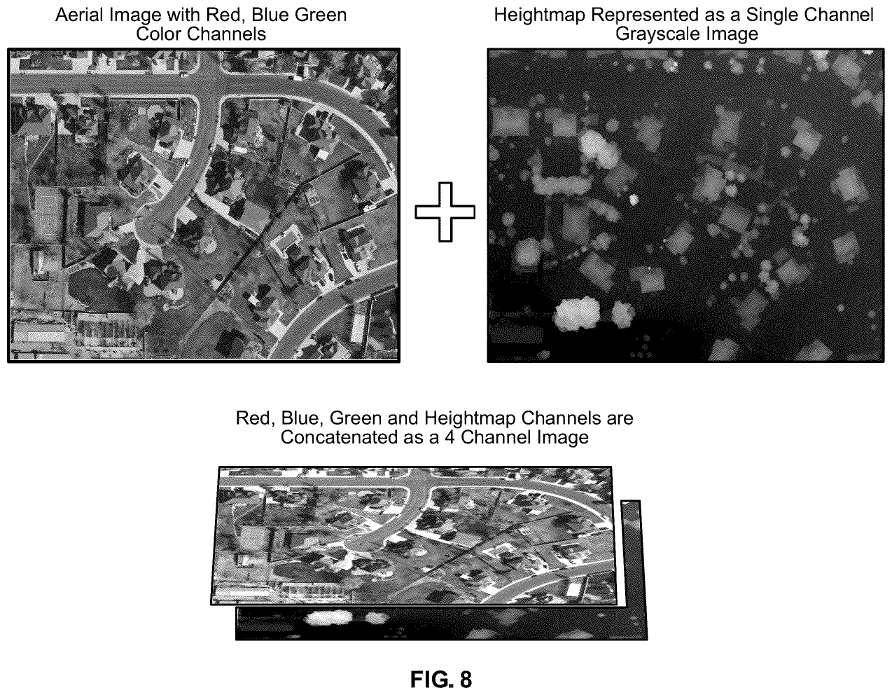

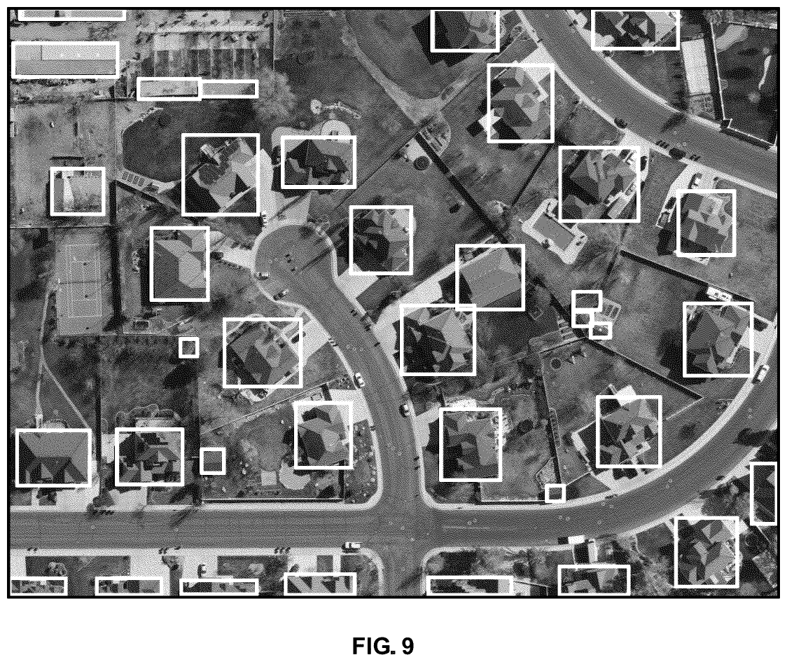

FIGS. 8-9 are illustrations of the processing steps of FIGS. 3-4. As can be seen in FIG. 8, the system combines an aerial image having red, blue, and green color channels with a heightmap represented as a single channel grayscale image to produce a combined 4-channel image that concatenates the red, green, blue, and heightmap channels. As can be seen in FIG. 9, the various bounding boxes or footprint polygons are generated by the system and displayed around each object of interest.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A computer vision system for detecting structures in aerial imagery and heightmap data, comprising:
a processor in communication with a database, the processor:
receiving an aerial image and at least one heightmap;
merging the aerial image with the at least one heightmap to create a combined image; and
processing the combined image using a computer vision model to detect one or more objects in the combined image.

2. The system of claim 1, wherein the processor merges the aerial image with the at least one heightmap by aligning the heightmap with the aerial image.

3. The system of claim 2, wherein the processor merges the aerial image with the at least one heightmap by mean shifting a plurality of values in the heightmap to zero.

4. The system of claim 3, wherein the processor merges the aerial image with the at least one heightmap by resizing the heightmap to the size of the aerial image.

5. The system of claim 4, wherein the processor merges the aerial iamge with the at least one heightmap by concatenating the aerial image with the heightmap to create the combined image.

6. The system of claim 1, wherein the computer vision model comprises a convolutional neural network.

7. The system of claim 1, wherein the detected one or more objects comprises one or more of a roof, a pool, a fence, or a boundary of a land property.

8. The system of claim 1, wherein the processor generates and places a bounding box or a polygon around each of the detected one or more objects in the image.

9. The system of claim 8, wherein the processor generates and assigns a structure classification to the bounding box or the polygon to indicate the structure of the object.

10. The system of claim 1, wherein the processor determines a geographic location of each of the one or more objects using two-dimensional spatial information of the aerial image and depth information of the heightmap.

11. The system of claim 1, wherein the processor stores data associated with the combined image including one or more of geographic coordinates, footprint polygons, bounding boxes, structure classifications, timestamps of the aerial image or the heightmap, or metadata in a geospatial database.

12. A computer vision method for detecting structures in aerial imagery and heightmap data, comprising:
receiving by a processor an aerial image and at least one heightmap;
merging the aerial image with the at least one heightmap to create a combined image; and
processing the combined image using a computer vision model executed by the processor to detect one or more objects in the combined image.

13. The method of claim 12, further comprising merging the aerial image with the at least one heightmap by aligning the heightmap with the aerial image.

14. The method of claim 13, further comprising merging the aerial image with the at least one heightmap by mean shifting a plurality of values in the heightmap to zero.

15. The method of claim 14, further comprising merging the aerial image with the at least one heightmap by resizing the heightmap to the size of the aerial image.

16. The method of claim 15, further comprising merging the aerial image with the at least one heightmap by concatenating the aerial image with the heightmap to create the combined image.

17. The method of claim 12, wherein the computer vision model comprises a convolutional neural network.

18. The method of claim 12, wherein the detected one or more objects comprises one or more of a roof, a pool, a fence, or a boundary of a land property.

19. The method of claim 12, further comprising and generating a bounding box or a polygon around each of the detected one or more objects in the image.

20. The method of claim 19, further comprising generating and assigning a structure classification to the bounding box or the polygon to indicate the structure of the object.

21. The method of claim 12, further comprising determining a geographic location of each of the one or more objects using two-dimensional spatial information of the aerial image and depth information of the heightmap.

22. The system of claim 1, further comprising storing data associated with the combined image including one or more of geographic coordinates, footprint polygons, bounding boxes, structure classifications, timestamps of the aerial image or the heightmap, or metadata in a geospatial database.
